(19) United States
(12) Patent Application Publication
(10) Pub. No.: US 2014/0285520 A1
(43) Pub. Date: Sep. 25, 2014

(54) WEARABLE DISPLAY DEVICE USING AUGMENTED REALITY

(71) Applicant: INDUSTRY-UNIVERSITY COOPERATION FOUNDATION HANYANG UNIVERSITY, Seoul (KR)

(72) Inventors: Jong-Il PARK, Seoul (KR); Byung-Kuk SEO, Seoul (KR)

(73) Assignee: INDUSTRY-UNIVERSITY COOPERATION FOUNDATION HANYANG UNIVERSITY, Seoul (KR)

(21) Appl. No.: 13/898,600

(22) Filed: May 21, 2013

(30) Foreign Application Priority Data
Mar. 22, 2013 (KR) 10-2013-0031109
Apr. 19, 2013 (KR) 10-2013-0043559

(51) Int. Cl. G06T 19/00

(52) U.S. Cl. CPC G06T 19/006
USPC 345/633

(57) ABSTRACT

A wearable display device using an augmented reality interface is disclosed. The disclosed device includes: a sensor unit configured to acquire image information; a watch recognition part configured to recognize a watch worn by a user from the acquired image information; an interface image generator part configured to generate a graphic interface image using the recognized watch as a reference and to show the graphic interface image in the acquired image; a control command recognition part configured to recognize a control command using the graphic interface image; and a processor configured to execute the recognized control command. The device provides the advantage of supporting various interface commands without requiring a separate interface device.

### CROSS-REFERENCE TO RELATED APPLICATIONS

This application claims the benefit of Korean Patent Application No. 10-2013-0031109, filed with the Korean Intellectual Property Office on Mar. 22, 2013, and Korean Patent Application No. 10-2013-0043559, filed with the Korean Intellectual Property Office on Apr. 19, 2013, the disclosures of which are incorporated herein by reference in their entirety.

### BACKGROUND

1. Technical Field

The present invention relates to a wearable display device.

2. Description of the Related Art

The HMD (head-mounted display), a representative type of wearable display device, was designed to provide a pilot with aviation information such as the altitude, velocity, etc., of the aircraft. Commercial products were first developed during the 1990's, and have attracted interest after 1997 due to their popularity. The HMD may be worn on the head like goggles and may provide the vision of a large screen showing virtual images. The display used here typically has a size of 1 inch or less, which may be magnified a hundredfold with the application of highly advanced optical technology.

With the development and commercialization of accessory devices such as the HMD, further growth is anticipated in the field of wearable computing devices. While previous efforts have focused on developing the HMD for movies or games, rapid advances in the fields of display devices and visual communication, as exemplified by the trends towards higher performance and smaller sizes in computer systems and LCD's, have led to research on wearable monitors, with some products already commercially available.

The HMD market faced many difficulties in the market for the past few years, due to relatively high prices, but the market is expected to grow dramatically in step with the trends in the wearable computer industry. The wearable HMD is expected to expand to industrial sites, logistics warehouses, maintenance sites for large-scale equipment such as cars, airplanes, and ships, etc., as well as to the field of sports entertainment, such as car racing.

In particular, developments in processor and software technology enable the miniaturization of computing devices, and as such, the HMD is expected to evolve beyond simply displaying images to becoming a personal computing device analogous to the smart phone.

FIG. 1 illustrates an example of a wearable display device that can operate as a computing device.

Referring to FIG. 1, a wearable display device according to the related art can include an image viewer unit 100, a connection unit 102, a main unit 120 that includes an interface unit 104 and a processor unit 106, and a frame 110.

The frame 110 may form the main body of the wearable display device and, for example, can have a structure similar to a pair of glasses, as illustrated in FIG. 1. The frame can be structured to be wearable on the user's head, and the other components of the wearable display device may be coupled onto the frame 110. The image viewer unit 100 may serve to show images and may be positioned in front of the user's eye.

The main unit 120, composed of the interface unit 104 and the processor unit 106, may be coupled to the frame 110, for example on a support part 110c of the frame 110 for wearing on the user's ear.

The interface unit 104 may provide an interface with which the user can input a control command. The interface unit 104 can include a number of buttons and can include a flat touch pad for inputting cursor movements. By using the interface unit 104, the user can input a necessary control command, such as for playing a video clip and searching information, for example.

The processor unit 106 may control the operations of the wearable display device for use as a computing device. The user's control commands inputted through the interface unit 104 may be provided to the processor unit 106, after which the processor unit 106 may then process the user's control commands.

A wearable display device according to the related art, such as that illustrated in FIG. 1, may be controlled by the user by way of an interface attached to the frame or by way of a separate interface device that communicates with the wearable display device.

For a wearable display device that only provides a simple display operation, an attached interface or a separate interface may allow sufficient control of the device. However, for a wearable display device that provides the functionality of a computing apparatus such as a smart phone, a greater variety of control commands may be needed, which may be difficult to accommodate with an interface of a limited size.

### SUMMARY

An aspect of the invention is to provide a wearable display device that can support various interface commands.

Another aspect of the invention is to provide a wearable display device that does not require a separate interface device.

One aspect of the invention provides a wearable display device that includes: a sensor unit configured to acquire image information; a watch recognition part configured to recognize a watch worn by a user from the acquired image information; an interface image generator part configured to generate a graphic interface image using the recognized watch as a reference and to show the graphic interface image in the acquired image; a control command recognition part configured to recognize a control command using the graphic interface image; and a processor configured to execute the recognized control command.

The watch recognition part may recognize the watch worn by the user by using pre-stored watch shape information and shape information of objects included in the acquired image.

The watch recognition part may recognize the watch worn by the user by using an infrared marker applied to the watch worn by the user.

The interface image generator part may generate the graphic interface image in a peripheral area of the watch with respect to the recognized watch.

The wearable display device may further include an interface means recognition part configured to detect from the graphic interface image whether or not a preconfigured interface means is overlapping the recognized watch.

The control command recognition part may recognize a motion of the interface means made while overlapping the recognized watch and determine a control command matching the recognized motion.

The control command recognition part may detect an action of the interface means moving in a particular direction, and the processor may move a cursor shown in the graphic interface image in correspondence to a direction and an extent of the detected movement.

The graphic interface image may include a cursor and a multiple number of graphic objects for control command selection, and the control command recognition part may recognize a preconfigured control command for executing a graphic object overlapped by the cursor.

Another aspect of the invention provides a wearable display device that includes: a sensor unit configured to acquire image information; a watch recognition part configured to recognize a watch worn by a user from the acquired image information; and an interface image generator part configured to generate a graphic interface image in a peripheral area of the recognized watch using the recognized watch as a reference and to show the graphic interface image on a display part.

Yet another aspect of the invention provides a method of controlling a wearable display device that includes: (a) acquiring image information; (b) recognizing a watch worn by a user from the acquired image information; (c) showing a graphic interface image in the acquired image; (d) recognizing a control command using the graphic interface image; and (e) executing the recognized control command.

Still another aspect of the invention provides a method of controlling a wearable display device that includes: (a) acquiring image information; (b) recognizing a watch worn by a user from the acquired image information; (c) showing a graphic interface image in the acquired image; (d) recognizing a control command using the graphic interface image; and (e) transmitting interface graphic object information selected by the user recognized in said step (d) to the watch; and (f) executing the recognized control command.

Certain embodiments of the invention provide the advantage of supporting various interface commands without requiring a separate interface device.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 illustrates an example of a wearable display device that can operate as a computing device.

FIG. 2 illustrates an example of a wearable display device according to an embodiment of the invention.

FIG. 3 illustrates a wearable display device according to an embodiment of the invention during use.

FIG. 4 illustrates an example of an augmented reality interface using a watch according to an embodiment of the invention.

FIG. 5 illustrates an example of an augmented reality interface using a watch according to another embodiment of the invention.

FIG. 6 illustrates an example of a control action implemented through an augmented reality interface using a watch according to an embodiment of the invention.

FIG. 7 illustrates another example of a control action implemented through an augmented reality interface using a watch according to an embodiment of the invention.

FIG. 8 is a block diagram illustrating the modular composition of a wearable display device according to an embodiment of the invention.

FIG. 9 is a block diagram illustrating the modular composition of a watch recognition part according to an embodiment of the invention.

FIG. 10 is a block diagram illustrating the modular composition of a watch recognition part according to another embodiment of the invention.

FIG. 11 is a flowchart illustrating a method of controlling a wearable display device according to an embodiment of the invention.

FIG. 12 is a block diagram illustrating the modular composition of a wearable display device according to still another embodiment of the invention.

FIG. 13 illustrates an interface image shown by the interface image generator part of a wearable display device according to still another embodiment of the invention.

FIG. 14 illustrates the arrangement structure of vibrating devices for a watch that interacts with a wearable display device according to yet another embodiment of the invention.

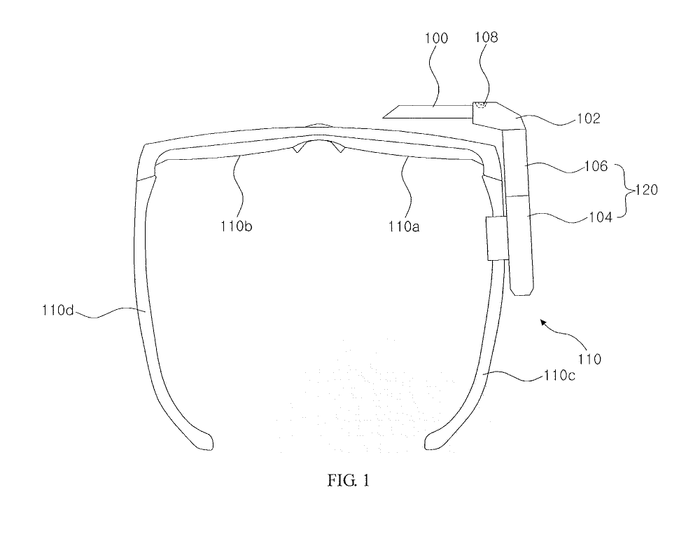

### DETAILED DESCRIPTION

As the present invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In describing the drawings, like reference numerals are used for like elements.

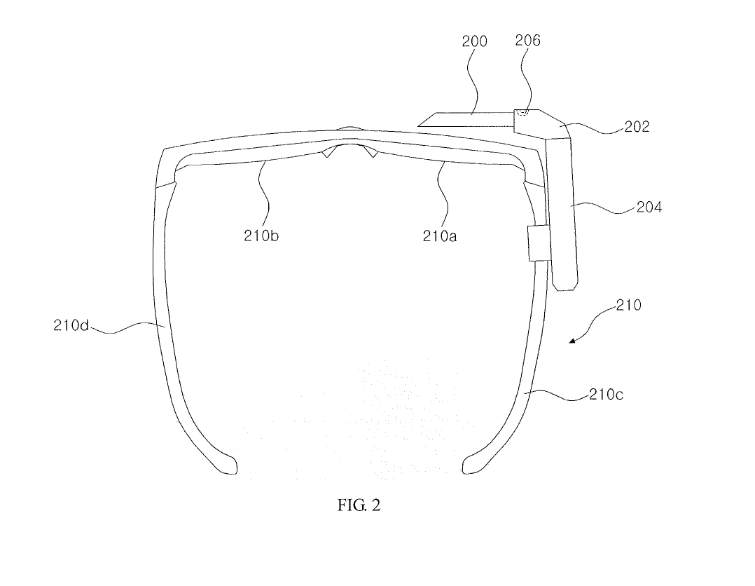

FIG. 2 illustrates an example of a wearable display device according to an embodiment of the invention.

Referring to FIG. 2, a wearable display device according to an embodiment of the invention can include an image viewer unit 200, a connection unit 202, a processor unit 204, a sensor unit 206, and a frame 210.

The frame 210 may form the main body of the wearable display device and can have a structure similar to that of a pair of glasses, for example, as illustrated in FIG. 2. The frame may be structured to be wearable on a user's head, and other components of the wearable display device may be coupled onto the frame 210.

The frame 210 can be made from various materials including metals and dielectrics, but using a dielectric material can be considered so as not to influence computing operations and RF signal reception.

While FIG. 2 illustrates an example in which the frame is of a similar form to that of a pair of glasses, the frame 210 can take any form that is wearable on the user's body. For instance, the frame can take the form of a helmet or a set of headphones.

In cases where the frame has a form similar to a pair of glasses, an example of which is illustrated in FIG. 2, the frame may include two lens-mounting parts 210a, 210b. A user who needs prescription glasses can mount lenses onto the lens-mounting parts 210a, 210b for use.

Also, the frame 210 may include two support parts 210c, 210d for wearing the frame on the user's ears.

The processor unit 204 may serve to control the operations of a wearable display device according to an embodiment of the invention. The processor unit 204 may receive control commands for an interface according to an embodiment of the invention as described below, and may perform the procedures corresponding to the commands.

The image viewer unit 200 may provide the user with image information by showing images. The image viewer unit 200 may be installed in front of the user's eye. The connection member 202 may connect the processor unit 204 with the image viewer unit 200 such that the image viewer unit 200 is fixed in front of the user's eye.

The connection member 202 can be shaped as an “U”, and due to this structure, the processor unit 204 can be coupled parallel to a support part 210c of the frame 210, while the image viewer unit 200 can be disposed orthogonally to the support parts 210c, 210d of the frame 210.

The connection member 202 can encase several cables for providing image-related information from the processor unit 204 to the image viewer unit 200.

The image viewer unit 200 can have a size of about 1 inch in the form of a micro-display and can show images using various known methods. It may be preferable to have the image viewer unit 200 made of a transparent material, so as not to obstruct the user's field of vision when there is no image being shown, but it is also possible to use an image viewer unit that does obstruct the field of vision.

In order to show an image on the image viewer unit 200, an external light source can be used, or a self-illuminating system can be used.

An example of using a self-illuminating system is to use OLED's. An OLED contains electrons and holes, which undergo an excitation state and then recombine to produce light. As it can emit light by itself, it is possible to show images without a separate external light source.

An example of using a system with an external light source is to use a transparent display. One such example is the TFT-LCD, which is structured such that light emitted from a fluorescent lamp is directed towards a liquid crystal panel by a device that reflects and disperses the light. The liquid crystal panel includes twisted nematic (TN) liquid crystals filled in between two glass sheets; the glass sheet on the side where light enters includes TFT and ITO pixels and a liquid crystal alignment layer, while the glass sheet on the other side is structured with a color filter and a coated liquid crystal alignment layer (polyimide).

Another example of using a system with an external light source is to use a reflective display. One example of a reflective display is the LCos, in which light is reflected with a reflective display to show images. A silicon substrate is mainly used for the display element, and it is possible to show images of a high resolution on a small display screen.

The sensor unit 206 may serve to acquire image information in a region corresponding to the user's line of sight, and the sensor unit 206 can include a camera. In order to acquire the image information for a region corresponding to the user's line of sight, it may be preferable to install the sensor unit 206 in front of the eye. For example, the sensor unit 206 may be installed coupled to the connection unit 202, as illustrated in FIG. 2, so as to capture images in a forward direction of the user.

In the mode with which the user performs an interface action, the image viewer unit 200 may show the photographed image information acquired by the sensor unit 206. The image viewer unit 200 may use augmented reality to superimpose a graphic interface over the photographed image acquired by the sensor unit 206. For example, the image viewer unit 200 may show a graphic interface for inputting various control commands, such as for making a telephone call, searching information, executing an application, etc., on the image viewer unit 200 in the form of augmented reality.

In order to show a graphic interface with augmented reality, a marker may be required, which may act as a reference point for the augmented reality image. The augmented reality image may be the image shown on the display superimposed over the real world with reference to a certain marker existing in reality. In an embodiment of the invention, the graphic interface may be shown on the image viewer unit 200 superimposed over the photographed image, with respect to a marker.

In an embodiment of the invention, a watch worn on the wrist may be recognized as a marker, and the graphic interface may be shown with respect to the watch.

The sensor unit 206 may serve to acquire the information for recognizing the watch worn on the wrist. The watch can be recognized by various methods. For example, it is possible to recognize the watch worn on the wrist by analyzing the shape information of objects included in the image acquired by the sensor unit 206.

Alternatively, it is also possible to recognize a wrist watch by attaching an infrared marker on the wrist watch. If a separate infrared marker is to be attached, the sensor unit 206 can include an infrared camera for recognizing the infrared marker.

If the infrared camera of the sensor unit 206 recognizes an infrared marker, the graphic interface may be shown with respect to the infrared marker.

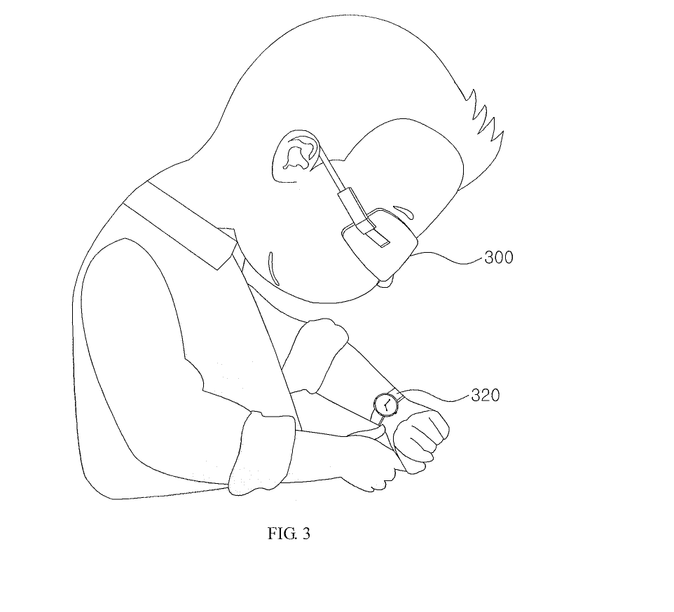

FIG. 3 illustrates a wearable display device according to an embodiment of the invention during use.

Referring to FIG. 3, a user may mount the wearable display device 300 on the head and view images provided by the image display unit 200. When a control of the wearable display device 300 is needed, the user may position a wrist watch 320 worn by the user such that the wrist watch enters the field of vision of the sensor unit 206 of the wearable display device.

The sensor unit 206 of the wearable display device 300 may acquire image information in the front of the user, including the wrist watch, and the wearable display device 300 may use the image information acquired at the sensor unit 206 to detect the user's wrist watch 320.

The wearable display device 300 may show an interface image using the detected wrist watch as a reference.

The wearable display device can include a separate button or some other interfacing means for interface activation, in order to activate the operation for detecting the wrist watch by using the sensor unit 206 (i.e. so that the wearable display device may switch to an interface mode).

That is, when the user wishes to control the wearable display device 300, the user may first press a button for interface activation, position the wrist watch within the field of vision of the sensor unit 206, and control the wearable display device by using the graphic interface that is provided with the detected wrist watch as a reference.

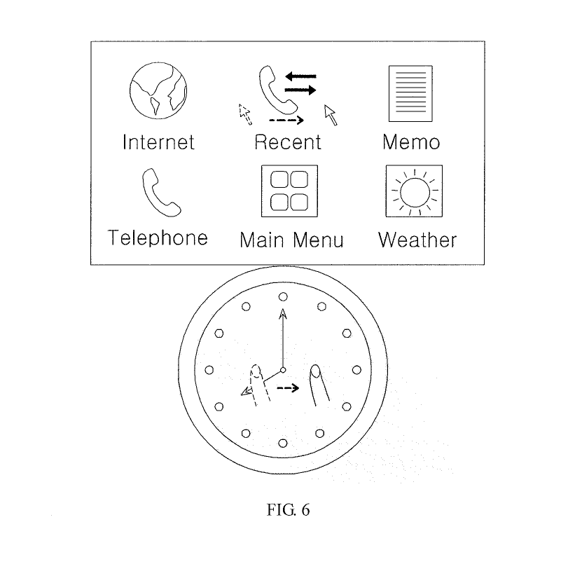

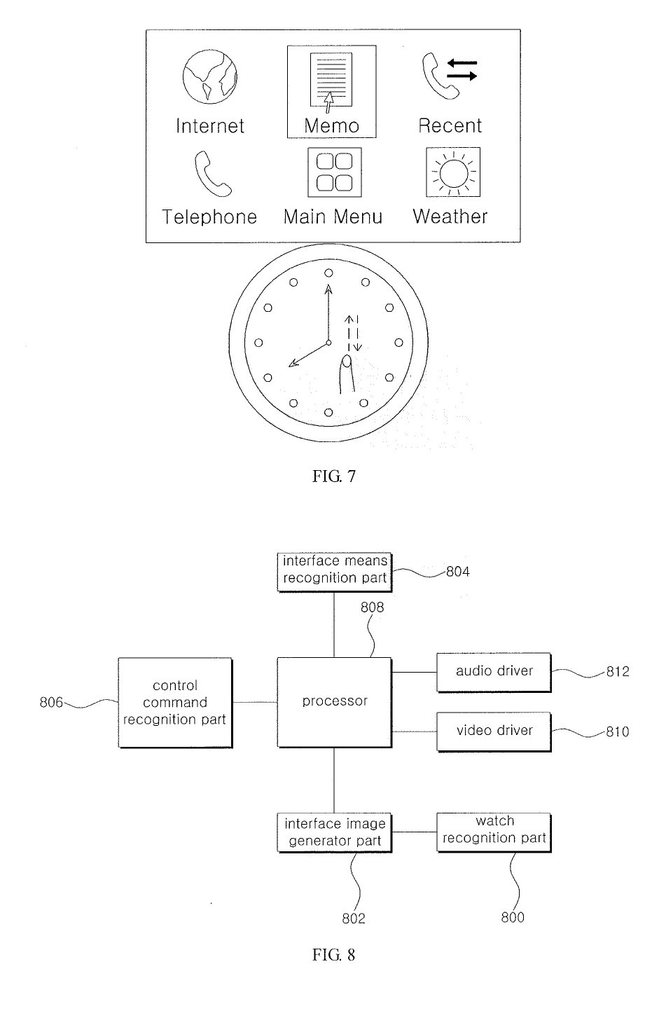

Alternatively, the wearable display device 300 can show an interface image if the wrist watch is positioned within the field of vision of the sensor unit 206 and the user's finger is in contact with or is near to the wrist watch. Here, the cases in which the use's finger is touching or near to the wrist watch can correspond to the control actions described later on in relation to FIG. 6 and FIG. 7. That is, the wearable display device 300 can show an interface image if a preconfigured interface means is overlapping the recognized watch.

FIG. 4 illustrates an example of an augmented reality interface using a watch according to an embodiment of the invention.

Referring to FIG. 4, when the watch is detected, the augmented reality interface can be shown in the form of a box-shaped graphic interface in a peripheral area of the watch, with the detected watch used as a reference. Several graphic objects can be displayed in the box-shaped graphic interface.

That is, an augmented reality interface according to an embodiment of the invention may be provided with reference to the watch, but may be shown in a peripheral area of the watch so as not to hide the watch itself.

From the graphic objects thus shown, the user can select a graphic object that corresponds to a desired interface command and can thereby transfer the required control command. The method of selecting a graphic object will be described later on in further detail.

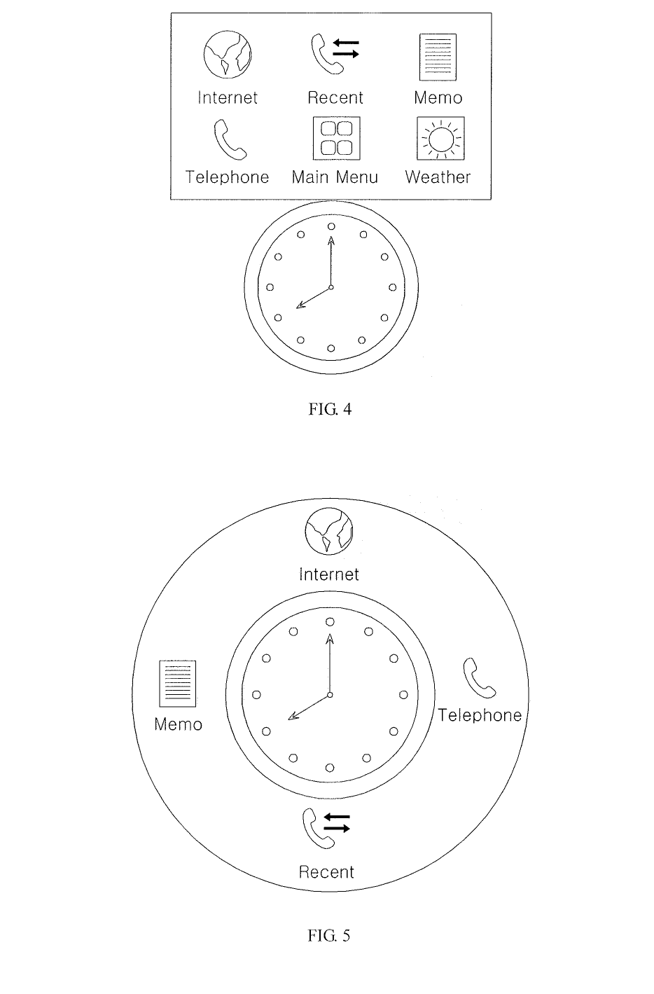

FIG. 5 illustrates an example of an augmented reality interface using a watch according to another embodiment of the invention.

Referring to FIG. 5, the graphic interface may be shown with reference to the detected watch in an area surrounding the perimeter of the watch. In cases where the watch has a circular shape, as illustrated in FIG. 5, the graphic interface can be shown in a peripheral area of the watch within a larger area concentric with the watch.

In cases where the watch has a rectangular shape, the graphic interface can be shown in a peripheral area of the watch within a larger rectangular area centered on the watch.

A graphic interface of a form surrounding the watch can include several graphic objects, making it possible to control the wearable display device by selecting a desired graphic object.

The graphic interface centered on the watch in a peripheral area of the watch can be provided in various ways other than those illustrated in FIG. 4 and FIG. 5.

FIG. 6 illustrates an example of a control action implemented through an augmented reality interface using a watch according to an embodiment of the invention.

Referring to FIG. 6, a cursor for selecting a particular graphic object may be shown in the graphic interface provided with reference to the watch.

The watch may serve as a flat pad on which to move the cursor by using an interface means (e.g. a finger or a touch pen).

When the interface means is positioned over the watch, the sensor unit 206 may detect the movement of the interface means. If the interface means is positioned over the watch in the image acquired by the sensor unit 206, the wearable display device may operate in a mode for detecting the movement of the interface means.

The cursor may move in correspondence to the detected movement of the interface means. If the user wishes to perform an Internet search, the user may move the interface means and position the cursor on the Internet graphic object.

Since it is sufficient for the interface means to overlap the watch in the acquired image, it may not be required for the user to contact the interface means with the watch when moving the cursor.

FIG. 7 illustrates another example of a control action implemented through an augmented reality interface using a watch according to an embodiment of the invention.

FIG. 7 illustrates a control action for selecting a graphic object overlapped by the cursor after moving the cursor to a desired graphic object as in FIG. 6.

Referring to FIG. 7, once the cursor has been moved onto a desired graphic object, the user may be required to perform an action for selecting the graphic object. Here, the user may position the interface means (finger or touch pen) over the watch and then perform a preconfigured selection action.

As illustrated in FIG. 7, one example of a selection action can be to move the finger up and then return it to its original position. Another example can include a double-click action.

Of course, it would be apparent to those skilled in the art that the preconfigured action for selection can be changed in various ways.

When a preconfigured selection action is detected after the cursor has been moved onto a particular graphic object, the wearable display device may execute an action for selecting the graphic object. For example, if the cursor is positioned over a memo graphic object and a selection action is detected while in this state, the wearable display device may execute a memo application.

As described above with reference to FIG. 2, an infrared marker can be attached to the wrist watch, and in this case, the position of the infrared marker can be selected in consideration of the control actions of the interface means. Since it can be difficult to recognize the infrared marker if the infrared marker is obscured by the interface means for inputting control actions, it may be preferable to attach the infrared marker to an upper portion of the wrist watch. For example, the infrared marker can be attached near the “12 o'clock” indication of the wrist watch, near the portion where the wrist watch connects to a watch strap, and so on.

FIG. 8 is a block diagram illustrating the modular composition of a wearable display device according to an embodiment of the invention.

A wearable display device according to an embodiment of the invention can include a watch recognition part 800, an interface image generator part 802, an interface means recognition part 804, a control command recognition part 806, a processor 808, a video driver 810, and an audio driver 812.

The watch recognition part 800 may serve to recognize the watch by using the image acquired by the sensor unit 206. The watch recognition part 800 can be activated when the user wishes to control the wearable display device. The watch recognition part 800 can be activated by the user pressing a particular button of the wearable display device or can also be activated by recognizing a preconfigured set of voice information that is outputted.

According to an embodiment of the invention, the watch recognition part 800 can recognize the watch based on whether or not there is an object having a shape similar to that of a watch shape that was learned beforehand, among the objects included in the acquired image.

FIG. 9 is a block diagram illustrating the modular composition of a watch recognition part according to an embodiment of the invention.

Referring to FIG. 9, a watch recognition part according to an embodiment of the invention can include a watch shape learning part 900, an object extraction part 902, and a target watch recognition part 904.

The watch shape learning part 900 may serve to learn beforehand the shape of the watch worn by the user. The watch shape learning part 900 may pre-acquire the shape information of the watch worn by the user through the sensor unit 206 and may store the acquired information as reference information. For example, the watch shape learning part 900 can store characteristics information of the watch worn by the user as reference information.

The watch shape learning part 900 can also store information on a typical watch shape, rather than a particular watch worn by the user, as reference information.

The object extraction part 902 may serve to extract the objects included in the image, from the image acquired by the sensor unit 206. The object extraction part 902 can extract the objects by using edge information in the image.

The target watch recognition part 904 may serve to determine whether or not there is an object matching the watch learnt beforehand, from among the extracted objects. For instance, the target watch recognition part 904 may compare the characteristics of a recognized object with the characteristics stored in the watch shape learning part 900, to determine whether or not it is the target watch.

According to another embodiment of the invention, an infrared marker can be applied (e.g. attached) beforehand to the watch worn by the user, and the watch recognition part 800 can recognize the applied marker to thereby recognize the wrist watch worn by the user. This embodiment may require attaching a marker beforehand but can increase the likelihood of recognition of the watch.

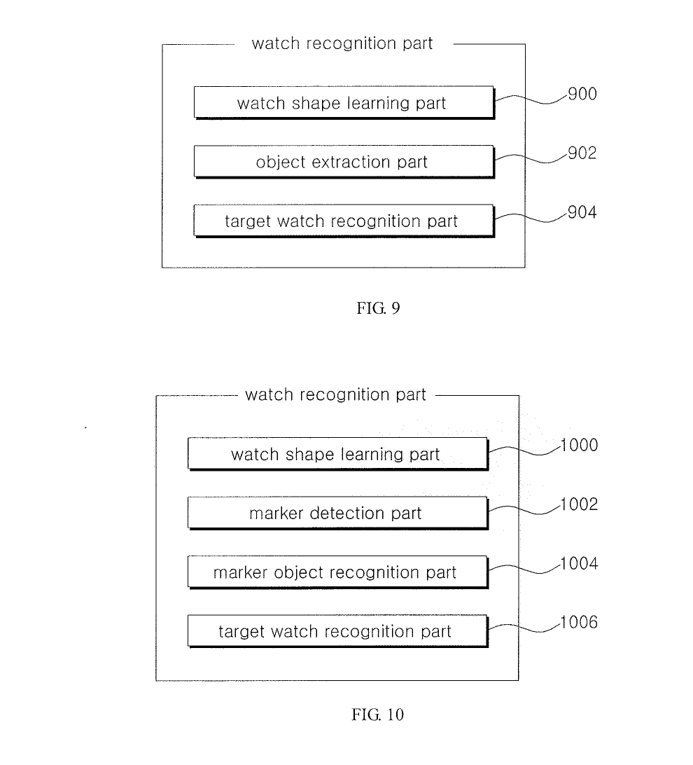

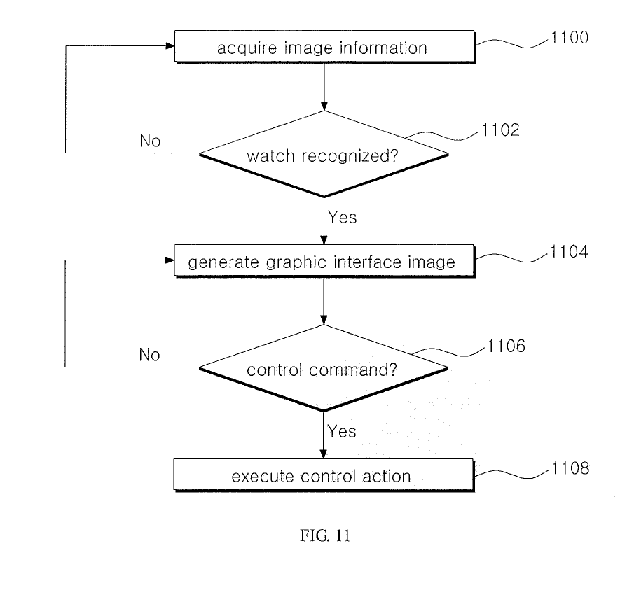

FIG. 10 is a block diagram illustrating the modular composition of a watch recognition part according to another embodiment of the invention.

Referring to FIG. 10, a watch recognition part 800 according to another embodiment of the invention can include a watch shape learning part 1000, a marker detection part 1002, a marker object recognition part 1004, and a target watch recognition part 1006.

The watch shape learning part 1000 may store information on the watch worn by the user or on a typical watch shape, as reference information. As described above, the characteristics information of the worn watch or a typical watch can be stored as reference information.

The marker detection part 1002 may serve to recognize the infrared marker attached to the watch worn by the user. The sensor unit 206 may include an infrared camera, and the marker attached to the watch may be recognized by using the image acquired through the infrared camera.

By using the marker recognized by way of the infrared camera, the marker object recognition part 1004 may acquire information on the object to which the marker is attached. For instance, characteristics information can be acquired of the object to which the marker is attached.

The target watch recognition part 1006 may serve to recognize the target watch by using the object information acquired at the marker object recognition part 1004 and the watch information learnt beforehand. As described above, the watch can be recognized by using the characteristics information.

The interface image generator part 802 may serve to generate a graphic interface image with respect to the watch, when the watch worn by the user is recognized. As illustrated in FIG. 4 and FIG. 5, a graphic interface may be shown with reference to the watch in a peripheral area of the watch, where the graphic interface may include several graphic objects for control commands.

The interface means recognition part 804 may serve to recognize an interface means overlapping the recognized watch. Here, the interface means may include a finger or a touch pen. A finger can be recognized by using color information, and a touch pen can be recognized by an infrared marker or shape recognition.

The control command recognition part 806 may serve to recognize the user's control commands by recognizing the motion of the recognized interface means. As described above with reference to FIG. 6 and FIG. 7, it may be recognized whether the control command is for moving the cursor or for selecting a particular graphic object.

The processor 808 may perform an operation corresponding to a control command recognized at the control command recognition part 806. As described above, an action of moving the cursor or executing a particular graphic object can be performed in correspondence to the motion of the interface means. The video driver 810 and the audio driver 812 may serve to generate the image information that is to be shown on the display part of the wearable display device and to generate the audio information that is to be outputted, respectively.

FIG. 11 is a flowchart illustrating a method of controlling a wearable display device according to an embodiment of the invention.

Referring to FIG. 11, the sensor unit 206 of the wearable display device may first acquire image information in a front direction (step 1100).

Once the image information of the front is acquired, it may be determined from the acquired image whether or not a wrist watch worn by the user is recognized (step 1102).

If the wrist watch worn by the user is recognized, a graphic interface image may be generated using the recognized wrist watch as a reference (step 1104). The graphic interface image may include several graphic objects for issuing control commands.

After the graphic interface image is generated, it may be determined whether or not the user performs a control command by overlapping an interface means over the watch (step 1106).

If the execution of a control command is recognized, the wearable display device may perform an action corresponding to the recognized control command (step 1108). As described above, an action for moving the cursor or executing a particular graphic object can be performed.

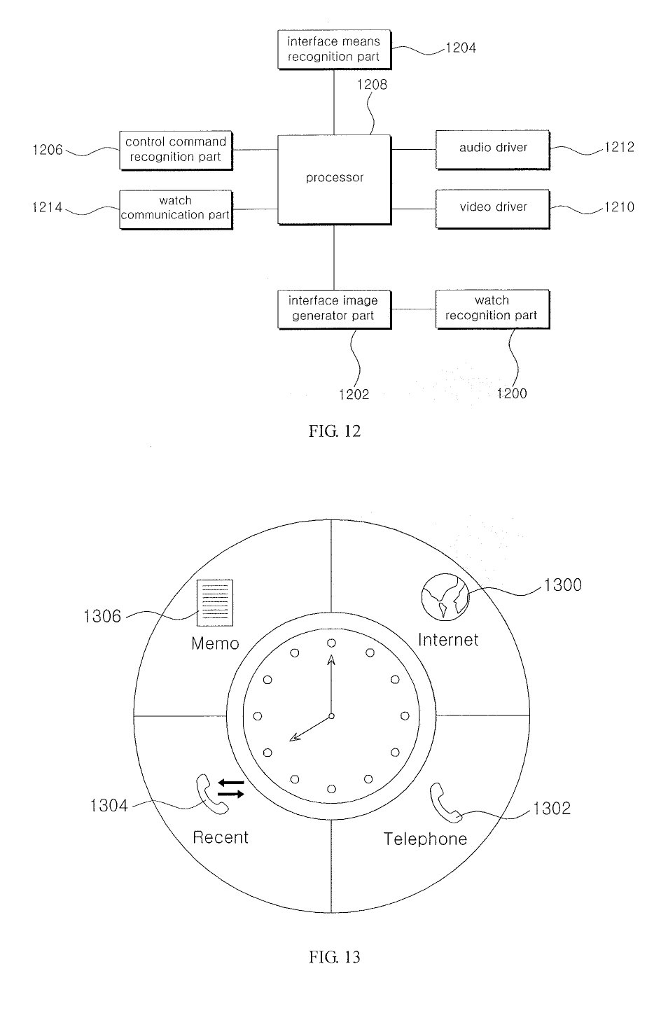

FIG. 12 is a block diagram illustrating the modular composition of a wearable display device according to still another embodiment of the invention, and FIG. 13 illustrates an interface image shown by the interface image generator part of a wearable display device according to still another embodiment of the invention.

A wearable display device according to this embodiment of the invention may include a watch recognition part 1200, an interface image generator part 1202, an interface means recognition part 1204, a control command recognition part 1206, a processor 1208, a video driver 1210, an audio driver 1212, and a watch communication part 1214, additionally including the watch communication part 1214 when compared to the wearable display device described previously.

The wearable display device according to this embodiment of the invention may recognize an action in which the interface means overlaps a particular graphic object of the augmented reality interface as an interface selection action. This is different from the action for selecting a particular interface by moving the interface means up and down described above with regard to the embodiment illustrated in FIG. 4 and FIG. 5.

For example, when the user's finger is used as an interface means, the overlapping by the user's finger over a particular graphic object of an interface image, such as that shown in FIG. 13, may be recognized as an action for selecting the graphic object.

In this case, unlike the embodiment described previously, the watch may not serve as a type of flat pad for interfacing.

That is, if an interface means overlaps the Internet graphic object 1300, from among the graphic objects of the interface illustrated in FIG. 13, then the control command recognition part 1206 may recognize this as a command to execute the Internet operation. Also, if the interface means overlaps the telephone graphic object 1302, then the control command recognition part 1206 may recognize this as executing a telephone call.

When control commands are transferred in this manner through a direct interaction with an interface graphic object provided by augmented reality, it may be difficult to perceive whether or not a control command has been properly transferred, because the user does not directly contact the menu.

Therefore, when an interface graphic object is selected, a wearable display device according to another embodiment of the invention may transfer information on the graphic object selected by the user through the watch communication part 1214. Here, the graphic object information that may be transferred can be position information of the graphic object or the type information of the graphic object.

For example, if the user selects the Internet graphic object 1300 in the graphic interface illustrated in FIG. 13, the watch communication part 1214 may transmit the Internet graphic object information to the watch. According to an embodiment of the invention, the position of the Internet graphic object may be transferred from the watch communication part 1214 to the watch. Since the Internet graphic object is positioned in the 11 o'clock direction, the information that the selected object is positioned in the 11 o'clock direction may be transferred. In cases where the watch is capable of identifying the indicated objects, it is also possible to transfer the information that the selected graphic object is the Internet graphic object.

According to another embodiment of the invention, the watch that interacts with the wearable display device may be equipped with vibration devices.

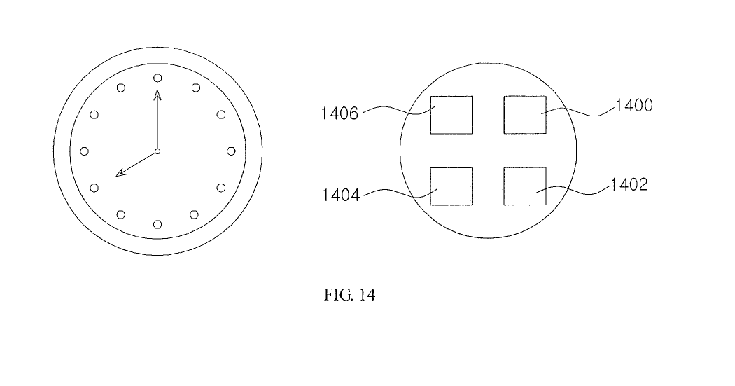

FIG. 14 illustrates the arrangement structure of vibrating devices for a watch that interacts with a wearable display device according to yet another embodiment of the invention.

Referring to FIG. 14, in the watch that interacts with a wearable display device according to another embodiment of the invention, there may be a number of vibration devices 1400, 1402, 1404, 1406 arranged in the same manner as the arrangement structure of the augmented reality graphic interface objects.

When information on the selected interface graphic object is received from the watch communication part 1214 of the wearable display device, the watch may vibrate a vibration device that corresponds to the received graphic object.

For example, if there is a transfer of information from the wearable display device that the graphic object positioned in the 11 o'clock direction has been selected, the watch may vibrate the vibration device 1400 positioned in the 11 o'clock direction from among the vibration devices 1400, 1402, 1404, 1406.

By way of the vibration of a particular vibration device from among the multiple number of vibration devices, the user is able to perceive that a graphic object has been properly selected.

While the present invention has been described above using particular examples, including specific elements, by way of limited embodiments and drawings, it is to be appreciated that these are provided merely to aid the overall understanding of the present invention, the present invention is not to be limited to the embodiments above, and various modifications and alterations can be made from the disclosures above by a person having ordinary skill in the technical field to which the present invention pertains. Therefore, the spirit of the present invention must not be limited to the embodiments described herein, and the scope of the present invention must be regarded as encompassing not only the claims set forth below, but also their equivalents and variations.

What is claimed is:

1. A wearable display device comprising:
a sensor unit configured to acquire image information;
a watch recognition part configured to recognize a watch worn by a user from the acquired image information;
an interface image generator part configured to generate a graphic interface image using the recognized watch as a reference and to show the graphic interface image in the acquired image;
a control command recognition part configured to recognize a control command using the graphic interface image; and
a processor configured to execute the recognized control command.

2. The wearable display device of claim 1, wherein the watch recognition part recognizes the watch worn by the user by using pre-stored watch shape information and shape information of objects included in the acquired image.

3. The wearable display device of claim 1, wherein the watch recognition part recognizes the watch worn by the user by using an infrared marker applied to the watch worn by the user.

4. The wearable display device of claim 1, wherein the interface image generator part generates the graphic interface image in a peripheral area of the watch with respect to the recognized watch.

5. The wearable display device of claim 4, further comprising:
an interface means recognition part configured to detect from the graphic interface image whether or not a preconfigured interface means is overlapping the recognized watch.

6. The wearable display device of claim 5, wherein the control command recognition part recognizes a motion of the interface means made while overlapping the recognized watch and determines a control command matching the recognized motion.

7. The wearable display device of claim 6, wherein the control command recognition part detects an action of the interface means moving in a particular direction, and the processor moves a cursor shown in the graphic interface image in correspondence to a direction and an extent of the detected movement.

8. The wearable display device of claim 6, wherein the graphic interface image has a cursor and a plurality of graphic objects for control command selection shown therein, and the control command recognition part recognizes a preconfigured control command for executing a graphic object overlapped by the cursor.

9. A wearable display device comprising:
a sensor unit configured to acquire image information;
a watch recognition part configured to recognize a watch worn by a user from the acquired image information; and
an interface image generator part configured to generate a graphic interface image in a peripheral area of the recognized watch using the recognized watch as a reference and to show the graphic interface image on a display part.

10. A method of controlling a wearable display device, the method comprising:
(a) acquiring image information;
(b) recognizing a watch worn by a user from the acquired image information;
(c) showing a graphic interface image in the acquired image;
(d) recognizing a control command using the graphic interface image; and
(e) executing the recognized control command.

11. The method of claim 10, wherein said step (b) comprises recognizing the watch worn by the user by using pre-stored watch shape information and shape information of objects included in the acquired image.

12. The method of claim 10, wherein said step (b) comprises recognizing the watch worn by the user by using an infrared marker applied to the watch worn by the user.

13. The method of claim 10, wherein said step (c) comprises generating the graphic interface image in a peripheral area of the watch with respect to the recognized watch.

14. The method of claim 13, further comprising:
detecting from the graphic interface image whether or not a preconfigured interface means is overlapping the recognized watch.

15. The method of claim 14, wherein said step (d) comprises recognizing a motion of the interface means made while overlapping the recognized watch and determining a control command matching the recognized motion.

16. The method of claim 15, wherein said step (d) comprises detecting an action of the interface means moving in a particular direction, and moving a cursor shown in the interface image in correspondence to a direction and an extent of the detected movement.

17. The method of claim 15, wherein the interface image has a cursor and a plurality of graphic objects for control command selection shown therein, and said step (d) comprises recognizing a preconfigured control command for executing a graphic object overlapped by the cursor.

18. A method of controlling a wearable display device, the method comprising:
(a) acquiring image information;
(b) recognizing a watch worn by a user from the acquired image information;
(c) showing a graphic interface image in the acquired image;
(d) recognizing a control command using the graphic interface image; and
(e) transmitting interface graphic object information selected by the user recognized in said step (d) to the watch; and
(f) executing the recognized control command.

19. A recorded medium readable by a digital processing device having recorded thereon and tangibly embodying a program of instructions for performing the method of claim 10.
